(19) United States
(12) Patent Application Publication
(10) Pub. No.: US 2024/0360966 A1
(43) Pub. Date: Oct. 31, 2024

(54) A LIGHTING DEVICE

(71) Applicant: SIGNIFY HOLDING B.V., EINDHOVEN (NL)

(72) Inventors: ZHI HONG XIE, SHANGHAI (CN); AI LING XU, SHANGHAI (CN); YAO ZHU, SHANGHAI (CN)

(21) Appl. No.: 18/687,912

(22) PCT Filed: Aug. 22, 2022
(86) PCT No.: PCT/EP2022/073280

§ 371 Date: Feb. 29, 2024

(30) Foreign Application Priority Data
Aug. 30, 2021 (WO) PCT/CN2021/115412
Sep. 24, 2021 (EP) 21198870.4

(51) Int. Cl. F21S 4/28; F21V 3/02; F21V 29/70; F21Y 103/10; F21Y 115/10

(52) U.S. Cl. CPC F21S 4/28; F21V 3/02; F21V 29/70; F21Y 2103/10; F21Y 2115/10

(57) ABSTRACT

A lighting device (10) comprises an elongate arrangement of LEDs (14) with outer rows (r1, r2) of LEDs extending along the length direction, and at least one inner row (r3) of LEDs between the outer rows (r1, r2) of LEDs. The pitch (p1) of the LEDs of the inner row (r3) is greater than the pitch (p2) of the LEDs along the first and second outer rows (r1, r2). Thus, the spottiness of the outer rows (r1, r2) is reduced by having a smaller pitch.

### FIELD OF THE INVENTION

This invention relates to lighting devices and in particular lighting devices which comprise an elongate carrier on which LEDs are mounted.

### BACKGROUND OF THE INVENTION

There are different types of elongate LED lighting device, including linear luminaires and tubular LED lamps. In all cases, the LEDs are discrete units, for example surface mount LED chips mounted as a regular array on a substrate such as a PCB.

A tubular LED lamp for example comprises a pin terminal at each end for reception in a so-called G13 lamp holder. The lamp comprises a plastic or glass tube, in particular a so-called T8 tube, an aluminum heat sink which carries the LED substrate, and a driver.

In order to achieve a desired range of light emission angles, desired light efficiency and lumen output, the LED substrate is typically mounted at atop of the optical cavity defined by the tube, facing downwardly.

A plastic tube is for example used with a plastic lamp holder, fixed with screws or glue, and a LED PCB substrate is mounted on an aluminum heat sink. This lamp has good mechanical properties, reliability and safety.

A glass tube is for example fixed to lamp end caps using epoxy glue. The LED substrate, comprising a PCB or flexible circuit board, is typically glued to the inside of the glass tube with silica gel.

One issue with lighting devices of this general type is that the individual LED chips may be visible. This is gives rise to a visible so-called “spottiness”. It arises if the LED chips are sufficiently far apart, and there is insufficient mixing of the optical output from adjacent LED chips, such that the individual LEDs can be seen from the outside of the lamp.

One way to reduce spottiness is to reduce the pitch between the LEDs. However this increases the number of LEDs needed, and is less cost efficient for a given desired overall lumen output.

### SUMMARY OF THE INVENTION

The invention is defined by the claims.

According to examples in accordance with an aspect of the invention, there is provided a lighting device, comprising:
an elongate carrier; and
an arrangement of LEDs along a length direction of the elongate carrier,
wherein the arrangement of LEDs comprises at least first and second outer rows of LEDs extending along the length direction, and at least one inner row of LEDs between the first and second outer rows of LEDs, wherein the pitch of the LEDs along the at least one inner row is greater than the pitch of the LEDs along the first and second outer rows.

This lighting device has multiple rows of LEDs, in order to create a desired light output flux. However, instead of arranging the LEDs in a regular grid, the inner row or rows have a larger pitch than the outer rows. The outer rows are those which are laterally closer to the sides of the carrier, and they are thus closer to the outside world (when the lighting device is viewed from either side). As a result, the spottiness of those rows of LEDs (i.e. the visibility of the individual LED chips) is more evident from outside the luminaire. By arranging those rows with a smaller pitch (i.e. with the LEDs more closely spaced), the spottiness is reduced for lateral viewing angles. In this way, the overall arrangement of LEDs gives a more uniform light appearance. For a given number of LEDs, by arranging the LEDs in this way with rows of different LED pitch, the overall spottiness of the lighting device is reduced compared to a regular LED array especially for a tubular LED lamp (TLED) with a high transmittance tube. In the meantime, the central intensity is lowered (relatively to the outer rows) thus the overall uniformity of the TLED is improved.

There may be three rows of LED (one in the middle and two outer rows), but there may be more than three rows, with progressively increasing pitch towards the middle.

The at least one inner row of LEDs is for example along a centerline of the carrier. The light output distribution is for example side-to-side symmetric in a plane perpendicular to the length direction of the elongate carrier.

The lighting device may further comprise a light transmissive housing around the carrier. It may be substantially transparent, or more preferably it is translucent, with a diffusive or scattering function. This reduces the visible spottiness.

The light transmissive housing for example comprises a tube, for example with a circular cross sectional shape. The tube may be made of plastic or glass.

The carrier is preferably mounted against an inner surface of the tube, away from a central axis of the tube. This maximizes the light transmission distance from the carrier to the tube, and hence maximizes light mixing before the LED output light reaches the tube.

The tube for example has a wall thickness adjacent the sides of the carrier which is greater than the opposite wall thickness, faced by the LEDs on the carrier.

This greater wall thickness is provided at the location of the outer rows of LEDs, which are closer to the wall. The greater wall thickness results in greater scattering by the material of the tube, so that the spottiness of those outer rows of LEDs is further reduced.

The carrier for example comprises a printed circuit board, and the lighting device further comprises a heat sink to which the printed circuit board is attached.

The heat sink is for example aluminum.

The lighting device may comprise a tubular LED or a linear luminaire.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a lighting device in the form of a tubular LED lamp;

FIG. 2 shows a cross section perpendicular to the length direction of the lighting device of FIG. 1.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a lighting device comprising an elongate arrangement of LEDs with outer rows of LEDs extending along the length direction, and at least one inner row of LEDs between the outer rows of LEDs. The pitch of the LEDs of the inner row is greater than the pitch of the LEDs of the first and second outer rows. Thus, the spottiness of the outer rows is reduced by having a smaller pitch.

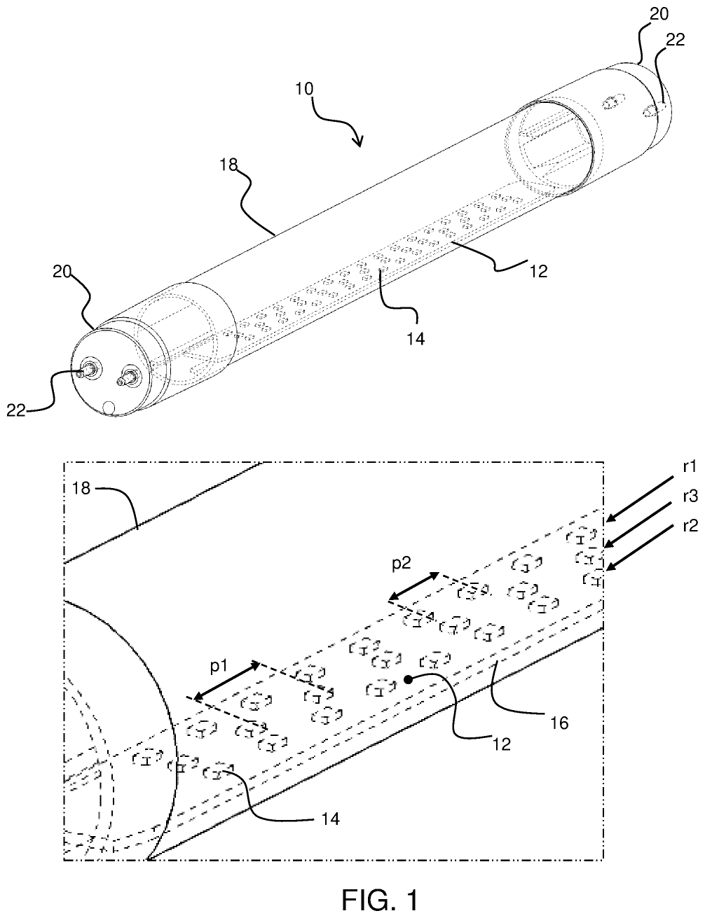

FIG. 1 shows a lighting device 10 in the form of a tubular LED (“TLED”) lamp, in simplified schematic form. FIG. 1 shows in the top image a perspective view showing hidden internal detail, and shows in the bottom image an enlarged view of a portion of the top image. TLED lamps can be used as a direct replacement for traditional fluorescent light tubes. In this way, the advantages of solid state lighting can be obtained without the expense of changing existing light fittings.

The lighting device comprises an elongate carrier 12, such as a rigid or flexible PCB, having an arrangement of LEDs 14 along a length direction of the elongate carrier 12.

The elongate carrier 12 is mounted on a heat sink 16, such as an aluminum heat sink, within an outer tubular housing 18. For a tubular LED, the outer tubular housing 18 is typically a circular cylindrical plastic or glass tube. The tube may however be non-circular, and tubular LEDs are thus not limited to the circular profiles of conventional fluorescent tubes.

The carrier 12 is mounted against an inner surface of the tube, away from a central axis of the tube. This maximizes the light transmission distance from the carrier to the tube, and hence maximizes light mixing before the LED output light reaches the tube.

End caps 20 are fixed to the ends of the tube, and comprise electrical connection pins 22. Each end cap has two pins 22 offset to each side from a central axis of the end cap 20, parallel to an elongate axis of the tubular housing 18. Each end cap connects electrically to an internal driver board (now shown) and to the PCB which mounts the LEDs.

In accordance with the invention, the arrangement of LEDs 14 comprises first and second outer rows r1, r2 of LEDs 14 extending along the length direction. These outer rows extend along the lateral sides of the carrier 12. There is an inner row r3 of LEDs between the first and second outer rows r1, r2.

The pitch p1 of the LEDs along the inner row r3 is greater than the pitch p2 of the LEDs along the first and second outer rows r1, r2.

The overall number of LEDs (i.e., in all rows in combination) is selected in order to create a desired light output flux. However, instead of arranging the LEDs in a regular grid, the inner row has a larger pitch p1 than the outer rows.

The outer rows are closer to the inner wall of the tubular housing 18 than the inner row. As a result, the spottiness of those outer rows of LEDs (i.e. the visibility of the individual LED chips) is normally more evident from outside the luminaire. There is less light mixing before the light reaches the tubular housing. Thus, the scattering or diffusion created by the tubular housing is less effective in hiding the spottiness of the light output from the outer rows of LEDs.

The level of diffusion or scattering created by the material of the tubular housing is for example chosen to achieve a desired visual appearance of the internal structure of the lighting device, in particular with the detailed internal design obscured. A more transparent housing will be more efficient and enable better control of the light output distribution, but a more diffuse or scattering housing material will better hide the spottiness of the LEDs.

By arranging the outer rows with a smaller pitch (i.e. with the LEDs more closely spaced), the spottiness is reduced, in particular for lateral viewing angles, compared to the middle row. In this way, the overall arrangement of LEDs gives a more uniform light appearance. For a given number of LEDs, by arranging the LEDs in this way with rows of different LED pitch, the overall spottiness of the lighting device is reduced compared to a regular LED array, and a more transparent housing material may be used, which enables better control of the light output distribution.

Thus, the light transmittance of the tubular housing may be maximized for a given level of spottiness that is deemed acceptable.

It is noted that the rows do not need to have perfectly uniform pitch. Thus, the pitches p1 and p2 may be considered to be the average pitch along the row length. It is also noted that there may be more than three rows. For example, there may be two or more middle rows. When there are more than three rows, there may be progressively increasing pitch towards the middle of the carrier, or else all the middle rows may have the same pitch.

The middle row is shown along a centerline of the carrier. If there are two (or any even number) of middle rows, they may be spaced either side of the centerline. The output distribution is for example side-to-side symmetric in a plane perpendicular to the length direction of the elongate carrier.

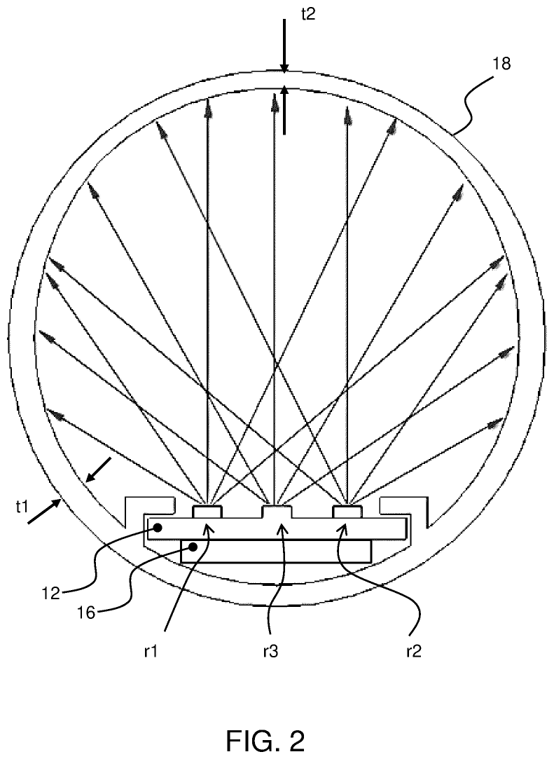

FIG. 2 shows a cross section perpendicular to the length direction of the lighting device. It shows the three rows r1, r2 and r3 of LEDs. It shows that the length of the light paths to the lateral sides of the lighting device is shorter for the outer rows r1, r2 than for the inner row r3. This difference in path length gives rise to a different visible spottiness for the different rows of LEDs, particularly when the lighting device is viewed from the side, and not from directly beneath the lighting device.

The light emitted from the sides of the lighting device is also outside the main output intensity distribution of the LEDs (e.g. covering a 120 degree angle, but with a peak intensity in the normal emission direction). The light intensity is thus lower at these steep lateral angles, and this again results in the LED structure being more visible. Again, this effect is compensated by the LED pitch selection explained above.

FIG. 2 shows an optional additional feature by which the tubular housing 18 has a wall thickness t1 adjacent the sides of the carrier which is greater than the wall thickness t2 faced by the LEDs on the carrier, i.e. opposite the LED carrier 12.

This greater wall thickness is thus provided at the location of the outer rows of LEDs, which are closer to the wall of the tubular housing. The greater wall thickness results in greater scattering by the material of the tube, so that the spottiness of those outer rows of LEDs is further reduced.

The thickness of the tubular housing may vary gradually between the values t1 and t2 thereby creating a gradual thickness change according to the intensity of the LEDs at different angles.

The example above is for a TLED lamp. However, the invention may be applied to any type of linear luminaire, comprising LEDs housed in an elongate housing or just mounted over an elongate carrier, to create a strip of light. The linear luminaire may use lenses or other beam shaping arrangements or covers to distribute the light output, and does not necessarily have a fully surrounding housing such as a tube.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A lighting device, comprising:
an elongate carrier;
an arrangement of LEDs along a length direction of the elongate carrier, and
a light transmissive housing around the carrier;
wherein the arrangement of LEDs comprises at least first and second outer rows of LEDs extending along the length direction, and at least one inner row of LEDs between the first and second outer rows of LEDs, wherein the pitch of the LEDs along the at least one inner row is greater than the pitch of the LEDs along the first and second outer rows; wherein the light transmissive housing comprises a tube.

2. The lighting device of claim 1, wherein the at least one inner row of LEDs is along a centerline of the carrier.

3. (canceled)

4. The lighting device of claim 1, wherein the tube has a circular cross sectional shape.

5. The lighting device of claim 1, wherein the tube is made of plastic or glass.

6. The lighting device of claim 1, wherein the carrier is mounted against an inner surface of the tube, away from a central axis of the tube.

7. The lighting device of claim 1, wherein the tube has a wall thickness adjacent the sides of the carrier which is greater than the wall thickness faced by the LEDs on the carrier.

8. The lighting device of claim 1, wherein the carrier comprises a printed circuit board, and the lighting device further comprises a heat sink to which the printed circuit board is attached.

9. The lighting device of claim 8, wherein the heat sink is aluminum.

10. The lighting device of claim 1, wherein the lighting device comprises a tubular LED.

11. The lighting device of claim 1, wherein the lighting device comprises a linear luminaire.
